(19) United States
(12) Patent Application Publication
(10) Pub. No.: US 2018/0171981 A1
(43) Pub. Date: Jun. 21, 2018

(54) INTEGRATED MODULAR WIND TURBINE

(71) Applicant: Hush Turb Ltd., Floriana (MT)

(72) Inventor: Mattias Bergstrom, Puerto de la Cruz (ES)

(73) Assignee: Hush Turb Ltd., Floriana (MT)

(21) Appl. No.: 15/382,734

(22) Filed: Dec. 18, 2016

(51) Int. Cl. F03D 9/00; F03D 3/00; F03D 3/06; F03D 9/25; H02K 7/18

(52) U.S. Cl. CPC F03D 9/002; F03D 3/002; F05B 2220/706; F03D 9/25; H02K 7/183; F03D 3/062

(57) ABSTRACT

An inexpensive modular micro wind turbine system is designed for residential as well as commercial and other installations in low-wind and high-wind environments. Simple replaceable components are easy to manufacture, install and sell in small flat packages to facilitate retail distribution (as a single standalone wind turbine module or a cascading series of daisy-chained modules). A substantially enclosed architecture and airfoil design prevents air molecules from easily escaping, providing a number of benefits over existing mast and propeller designs—including enhanced safety, noise reduction, improved energy efficiency and a self-braking effect that causes the rotational speed of the wind turbine to reach an equilibrium before reaching a maximum survival speed, thereby enhancing safety while avoiding the need for an external braking mechanism. An integrated generator (including conducting coils in each stator in proximity to magnets in each rotor) avoids the need for an external generator.

### BACKGROUND

### Field of Art

The present invention relates generally to the field of wind turbines, and in particular to wind turbines suited to residential as well as commercial and other applications.

### Description of Related Art

As the cost of electricity continues to rise, and concerns about climate change become more urgent, there is an ever-increasing demand for affordable alternative energy sources. Large energy providers with existing distribution infrastructure have begun a gradual shift toward including various forms of renewable energy in their arsenal. Yet, the most promising forms of renewable energy tend to be concentrated in remote rural areas better suited to addressing their shortcomings.

For example, large solar plants are more likely to be located in areas that receive frequent sunlight (to minimize the inherent problems of darkness and cloud cover). Similarly, large wind farms are more likely to be located in areas of consistently high winds (to minimize the inherent problem of intermittent periods of little or no wind). Yet, these large remote installations face significant limitations apart from energy generation. In particular, they lack the distribution infrastructure to deliver that energy over large distances to consumers in a cost-effective manner.

As a result, there is an increasing demand for “distributed generation” of renewable energy (also referred to as “distributed energy” or “on-site generation”), in which energy is generated at or near the consumers of that energy, often with the added cost-saving bonus of delivering excess capacity back into the existing centralized utility power grid. In short, the energy distribution problem is largely alleviated by distributing energy generation.

Photovoltaics is currently the most popular form of distributed renewable energy, and is gaining traction on residential rooftops (as well as commercial facilities) as costs begin to decrease. Yet, it remains a relatively expensive proposition, often requiring years for manufacturers, distributors and consumers to recoup costs. Moreover, the aesthetics and relative permanence of solar panel installations continue to present significant barriers to their adoption.

Residential and other “micro” wind turbines face even greater obstacles that have thus far prevented any significant level of public adoption. In addition to their high cost (due to their complex structures and need for external generators and external braking mechanisms—see, e.g., www ecosnippets.com/alternative-energy/silent-rooftop-wind-turbines/ and www.vortexis.com), they are often quite noisy due to the “whining” of propellers that create significant turbulence as air molecules chaotically bounce off propeller edges. They typically require high masts to reach higher-speed winds, which present significant safety concerns, particularly during intermittent turbulent wind conditions (e.g., should a mast fall off a rooftop or a spinning propeller break away from the wind turbine). Moreover, they require a significant amount of land and open space, thereby limiting their suitability for residential applications. Their exposure to the elements also increases their vulnerability to storms and other weather events, creating similar safety as well as reliability concerns.

There is thus a need for a cost-effective micro wind turbine that can be deployed in residential as well as commercial and other applications, and can address the above-mentioned problems of excessive noise, safety concerns, complexity of design, need for expansive land area and vulnerability to the elements.

### SUMMARY

The present invention, unlike existing “mast and propeller” wind turbines, employs a starkly different approach to micro wind turbine architecture. In one embodiment, the wind turbine system of the present invention includes one or more substantially enclosed modules, each of which can function as a standalone wind turbine, or as part of a wind turbine system containing a bank of multiple “daisy-chained” modules.

Each module is supported by dual circular “stators” or non-rotatable holders, one on each end, each of which is attached to a circular “rotor” disk that rotates as the three “airfoils” or wings attached between the rotors rotate in response to a threshold wind speed. Unlike existing wind turbines, which include some form of connector or extending rod attached to an external generator and gearbox or external braking mechanism, each module of the present invention includes its own integrated generators and self-braking functionality (saving the weight, manufacturing and installation complexity and cost of external units).

In one embodiment, by affixing conducting “coils” to each of the stators, and magnets to each of the rotors, the present invention integrates the components of a generator (conducting coils and magnets) into the components of a wind turbine (stators, rotors and attached airfoils) to create an integrated dual generator. In this manner, each wind turbine module generates electricity as the magnets rotate with each rotor in proximity to the conducting coils attached to each stator, thereby effecting a “built-in” integrated dual generator (which avoids the need for an external generator).

The three airfoils in this embodiment are constructed as “Fibonacci-shaped” curves that together create a substantially enclosed module that forces air molecules into a central collection area of the module—i.e., creating a vortex due to the centripetal force generated by the rotating airfoils. The curved shape and relative location of the airfoils cause the air molecules to endure multiple collisions with the airfoils, thereby releasing more of the kinetic energy from the air molecules, which is converted into mechanical energy in the form of rotating airfoils and rotors (and ultimately into electrical energy as noted above).

As a result of these multiple collisions with the airfoils, the efficiency of energy generation inside the wind turbine is increased. In other words, more energy is captured/converted per air molecule. External noise is also reduced as slower air molecules (due to the capture/conversion of more of their kinetic energy during each collision with the airfoils) are released in a directed (or laminar) flow out the “back end” of the module—as opposed to the more chaotic turbulent flow which results from air molecules bouncing off the edge of a propeller blade.

Moreover, as wind speed increases, the density (and thus pressure) of these slower air molecules being forced (by increasing centripetal force) into the central collection area also increases. In other words, the air molecules are compressed, forcing more air molecules into the central collection area. As more air molecules collide with the airfoils, more kinetic energy is released, thereby further increasing the energy efficiency of the wind turbine module.

However, given the finite amount of space within the wind turbine module (in particular within the central collection area), air molecules are gradually prevented from entering the increasingly dense “high pressure” central collection area, and they instead flow out of the back end of the wind turbine. As a result, the rate of compression (and thus the acceleration of the airfoils) gradually decreases, thereby creating a “self-braking” effect that protects the integrity of the wind turbine, enhances safety and avoids the need for an external braking mechanism. In other words, even as wind speed continues to increase, the wind turbine module reaches an equilibrium as it approaches a maximum rotational speed, which is designed in one embodiment to be slightly below the “survival speed” that would jeopardize the integrity of the wind turbine module.

In one embodiment, the wind turbine system is designed to be installed as one or more horizontally-oriented low-profile modules near the apex of a roofline in order to funnel an optimal number of air molecules into each module of the wind turbine system. It should be noted, however, that no particular axis orientation is required. Vertically-oriented modules, as well as horizontally-oriented modules, may be employed depending upon the application.

An external rectifier serves to distribute the electricity generated by the wind turbine system—e.g., into a home for internal use, with excess capacity distributed back into the existing centralized utility power grid or stored in local battery banks. Built-in WLAN circuitry enables communication of usage, diagnostic and other data over local and wide-area networks, including the Internet.

In other embodiments, a free diagnostic service is employed to monitor and alert consumers and service technicians regarding system status. The service tracks and stores usage information and statistics on a periodic basis (e.g., the amount of energy generated and transferred to and from the grid per minute, hour, day, month, etc.), provides data export and visualization functionality, and identifies optimization strategies (e.g., regarding the tradeoffs of additional daisy-chained modules). A premium service provides online data storage, mobile access, integration with third-party systems, and a variety of other features and services.

In yet another embodiment, an online community enables the sharing of data among neighbors and friends, as well as via traditional social media services. An economic service enables consumers and other users to participate in collective negotiations with enterprise or local power companies, including smaller distribution entities.

By greatly simplifying the components of a micro wind turbine (e.g., in one embodiment, a single wind turbine module includes two stators with conducting coils, two rotors with magnets, three airfoils and a rectifier), the present invention enables the manufacturing and distribution of an affordable wind turbine system for residential as well as commercial and other applications. Components are not only inexpensive, but are replaceable and can be sold in small flat packages that facilitate easy retail distribution.

The wind turbine system, whether including one or multiple modules, is affordable, easy to install, aesthetically pleasing (e.g., no high mast), efficient, quiet and safe (e.g., doesn't kill birds, bats and other flying creatures), even in extremely turbulent wind conditions. It can be installed on virtually any residential rooftop (no need for a wide-open area) without the need for an external mast (much less one that extends high above the roofline). The built-in generators and self-braking functionality avoid the need for an external generator or external gearbox or safety brake, thus greatly reducing cost as well as complexity.

In addition to residential installations (including areas lacking sufficient sunlight), the substantially enclosed wind turbine system of the present invention Is ideal for commercial facilities, such as office buildings, warehouses and manufacturing facilities (as well as government buildings) where minimal land utilization is of particular importance. Other applications include both onshore and offshore wind farms (e.g., with a rotating mast to orient the system dynamically in accordance with known wind patterns), and hilltops, mountains and cliffs where wind speeds tend to be relatively high (and wind is funneled in a consistent direction, much like a residential rooftop). Still other applications include farming and other industries with relatively high electrical usage, villas and second homes, weekend homes, recreational cabins and campsites (avoiding the problem of stocking diesel fuel), sailboats and an array of other applications.

### BRIEF DESCRIPTION OF DRAWINGS

FIG. 1 is an image illustrating an isometric projection of one embodiment of roof-mounted cascading wind turbine modules of the present invention.

FIG. 2 is an image illustrating an isometric projection of one embodiment of a single wind turbine module of the present invention.

FIG. 3 is an image illustrating an exploded view of one embodiment of key components of a single wind turbine module of the present invention, including two stators, two rotors and three airfoils.

FIG. 4 is an image illustrating an isometric projection of one embodiment of one of the two rotors of each single wind turbine module of the present invention, into which the magnet elements of an integrated generator are incorporated.

FIG. 5 is an image illustrating a profile view of one embodiment of one of the two stators of each single wind turbine module of the present invention, into which the coil elements of an integrated generator are incorporated, and from which electrical power is generated and distributed to its intended destination.

FIG. 6 is an image illustrating an isometric projection of one embodiment of one of the three airfoils of each single wind turbine module of the present invention.

FIG. 7 is an image illustrating a profile view of one embodiment of all three airfoils of each single wind turbine module of the present invention, the spacing of which creates a central collection area into which air molecules collect.

FIG. 8 is a flowchart illustrating one embodiment of a dynamic process by which a single wind turbine module (as well as multiple cascading wind turbine modules) of the present invention generates electricity from wind.

FIG. 9A is an image illustrating a profile view of an “electricity generation” stage of the process described in FIG. 8, in which the flow of air molecules through one embodiment of a single wind turbine module of the present invention causes the airfoils, rotors and magnets to rotate and generate electricity via built-in integrated generators.

FIG. 9B is an image illustrating a profile view of an “increased energy efficiency” stage of the process described in FIG. 8, in which the flow of air molecules through one embodiment of a single wind turbine module of the present invention results in multiple collisions with the airfoils, thereby accelerating the rotation of the airfoils, rotors and magnets, and thus increasing energy efficiency by capturing and converting more energy per air molecule.

FIG. 9C is an image illustrating a profile view of an “additional increased energy efficiency” stage of the process described in FIG. 8, in which the flow of air molecules through one embodiment of a single wind turbine module of the present invention is directed into a central collection area, thereby further increasing energy efficiency as air molecules are compressed, allowing more air molecules to collide with the airfoils, while decreasing external noise by releasing slower air molecules in a directed flow out the back end of the wind turbine module.

FIG. 9D is an image illustrating a profile view of a “self-braking” stage of the process described in FIG. 8, in which the flow of air molecules through one embodiment of a single wind turbine module of the present invention is gradually prevented from entering the central collection area, thereby creating a self-braking effect in which the rotational speed of the wind turbine reaches an equilibrium that enhances safety while avoiding the need for an external braking mechanism.

### DETAILED DESCRIPTION

As will be described in greater detail below, the wind turbine system of the present invention provides an inexpensive, modular micro wind turbine that increases energy efficiency, whether installed in a relatively low-wind or high-wind area. It integrates easily into rural, suburban and urban areas, including high-density cities. Its modular design enables a daisy-chained interconnection of individual wind turbine modules for even greater electricity output. Though it can be installed on walls and fences, or even as a standalone structure, it is specifically designed in one embodiment to achieve even greater efficiency when installed near the apex of a roofline, which funnels wind from various directions into each wind turbine module.

By integrating generators into the components of the wind turbine (e.g., conducting coils in each stator in proximity to magnets in each rotor), the wind turbine system of the present invention avoids the complexity and expense of an external generator. This substantially enclosed architecture also provides significant safety features as compared to existing mast and propeller designs—e.g., eliminating the risk of a mast falling off a rooftop or a spinning propeller breaking away from the wind turbine.

Moreover, the substantially enclosed shape of the airfoils prevents air molecules from easily escaping the wind turbine, which provides a number of benefits, including significant noise reduction by releasing slower air molecules in a directed flow out the back end of the wind turbine (as compared to the turbulence created when air molecules chaotically bounce off propeller edges).

Other benefits of “trapping” air molecules within a substantially enclosed space include increased energy efficiency, as the air molecules endure multiple collisions with the airfoils, enabling the capture/conversion of more of the kinetic energy from the air molecules. Moreover, as these slower air molecules (having lost some of their kinetic energy) are forced into the central collection area (e.g., by the centripetal force generated by the rotating airfoils), the air molecules are compressed, allowing more air molecules to endure collisions with the airfoils, thereby further increasing the energy efficiency of the wind turbine. In one embodiment, the shape and relative location of the airfoils enables the wind turbine to work in environments ranging from relatively low wind speeds (e.g., 1-2 m/sec) to those exhibiting much higher-speed more turbulent winds.

As noted above, given the finite amount of space within the wind turbine module (in particular within the central collection area), air molecules are gradually prevented from entering the increasingly dense “high pressure” central collection area, and they instead flow out of the back end of the wind turbine. As a result, the rate of compression (and thus the acceleration of the airfoils) gradually decreases, thereby creating a “self-braking” effect that protects the integrity of the wind turbine, enhances safety and avoids the need for an external braking mechanism. In other words, even as wind speed continues to increase, the wind turbine module reaches an equilibrium as it approaches a maximum rotational speed, which is designed in one embodiment to be slightly below the survival speed that would jeopardize the integrity of the wind turbine module.

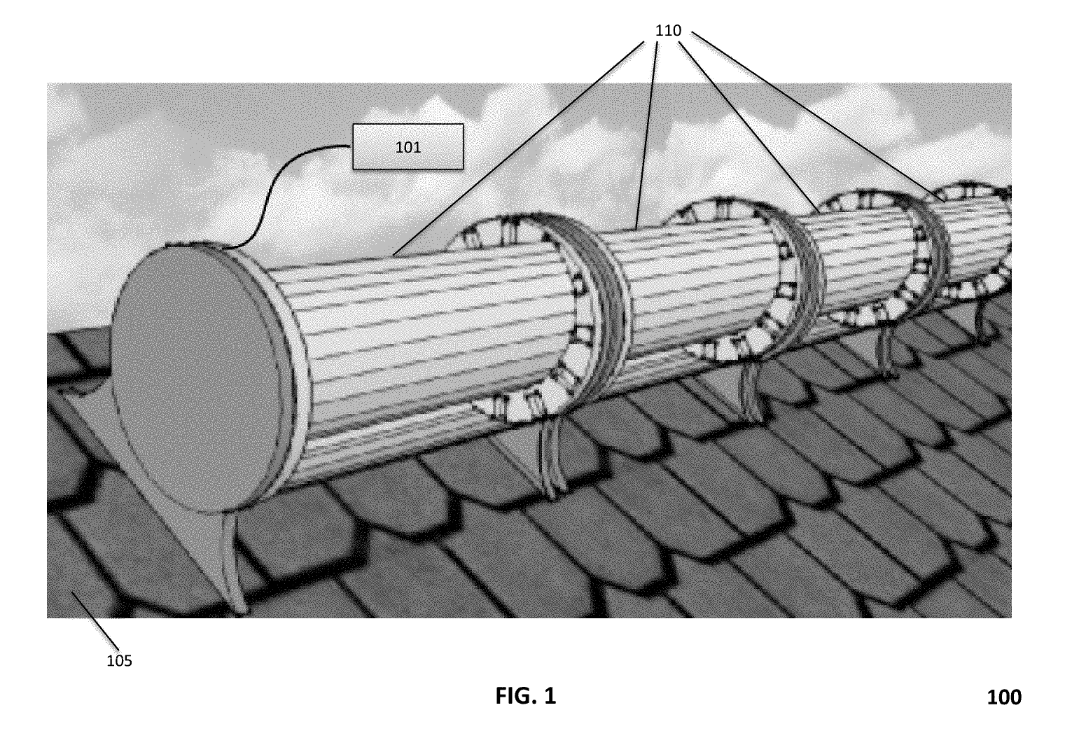

Turning to FIG. 1, image 100 is an isometric projection of one embodiment of roof-mounted cascading wind turbine modules of the present invention. Each module 110 of wind turbine system 101 is oriented horizontally near the apex of a residential rooftop 105. This orientation and placement not only provides an aesthetically pleasing low-profile installation, but also leverages the roof pitch to funnel the wind hitting rooftop 105 into each module 110 of wind turbine system 101. In other words, rooftop 105 serves as a “wind collector” that directs wind from various directions into wind turbine system 101. In this embodiment, wind turbine system 101 can be referred to as a “Horizontally Deployed Vertical Axis Wind Turbine” (HDVAWT) or a “Hybrid Horizontal-Vertical Wind Turbine” (HHVWT).

It should be noted that wind direction patterns tend to be fairly consistent, though the precise angle of the wind direction relative to wind turbine system 101 is less critical near the apex of a roofline, given that the wind “follows the roofline” as noted above. Moreover, other applications beyond residential and commercial rooftops and analogous structures, such as wind farms, sailboats and other moving vehicles, will also benefit from the embodiments of the present invention described below.

As noted above, wind turbine system 101 can be installed as a single module 110 that acts as a standalone wind turbine, or as a cascading series of “daisy-chained” modules 110, as illustrated in FIG. 1, that work together to generate electricity. Though not shown in FIG. 1, the conducting coils of adjacent modules 110 are interconnected (in a manner evident to one skilled in the art) to facilitate the distribution of electricity generated by each module 110 into a residence or other facility for internal use, with excess capacity distributed back into the existing centralized utility power grid or stored in local battery banks.

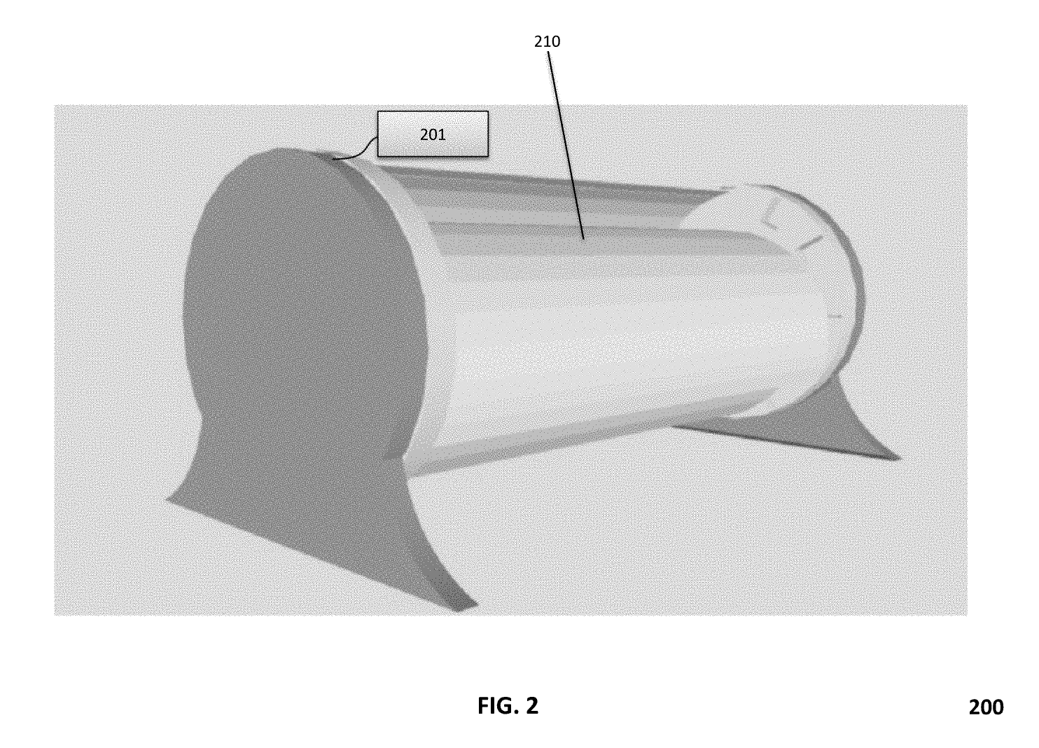

Image 200 of FIG. 2 is an isometric projection of one embodiment of a single wind turbine module of the present invention. Module 210 illustrates the substantially enclosed nature of wind turbine system 201, whether implemented as a single standalone wind turbine, or as a cascading series of daisy-chained modules. As will be discussed in greater detail below, the substantially enclosed design of module 210 provides significant benefits regarding the flow of air molecules within wind turbine system 201.

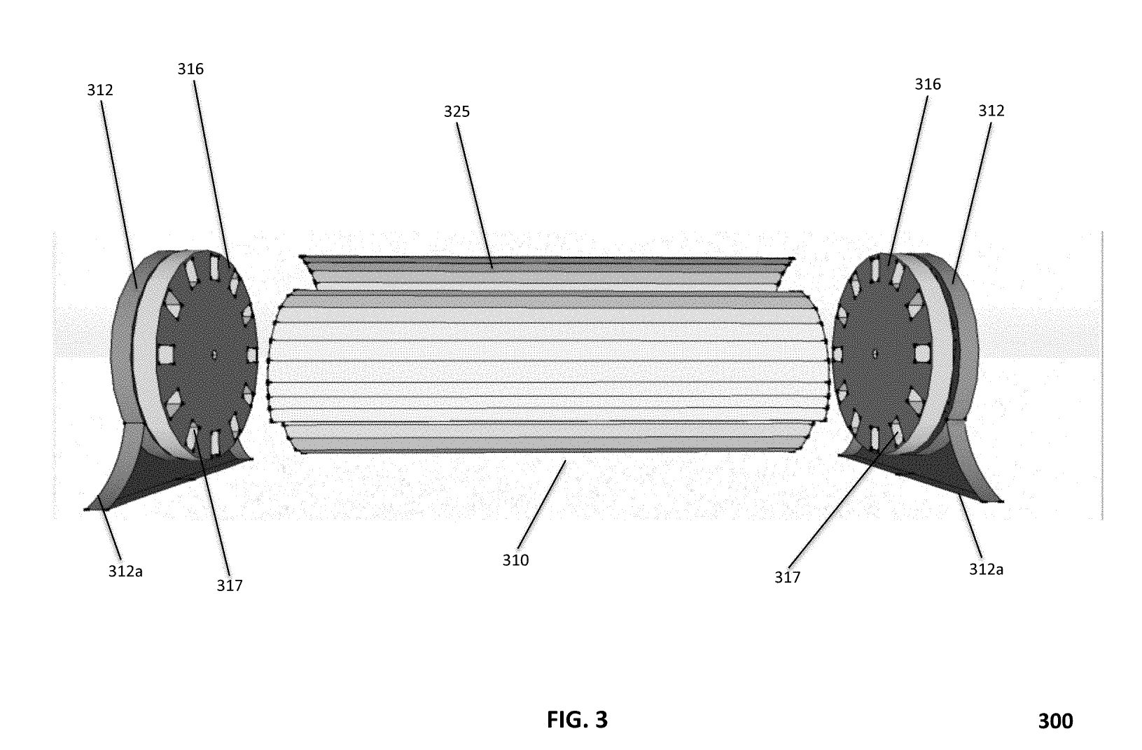

Image 300 of FIG. 3 illustrates an exploded view of one embodiment of key components of a single wind turbine module of the present invention. In this embodiment, module 310 includes two stators 312 (with conducting coils—not shown), two rotors 316 (with slots 317 for magnets—not shown) and three airfoils 325 forming a substantially enclosed wind turbine module 310 when each stator 312 is attached to its corresponding rotor 316 (in one embodiment employing ball bearings along the periphery to facilitate free rotation of the rotors 316), which in turn are attached to each end of the three airfoils 325.

In this embodiment, rotors 316 form a rotatable circular frame having left and right concentric disks, which support a plurality of airfoils 325, which are arranged concentrically on the rotors 316. The rotors 316 and attached airfoils 325 are maintained in a fixed position (relative to the rest of the module 310, though still being rotatable) by attaching left and right rotors 316 to respective left and right circular stators 312, supported by a mount/stand 312a for attaching stators 312 (and thus each module 310) to a structure, such as a residential rooftop 105.

The rotors 316 include magnets attached to magnet slots 317, which form a key component of dual integrated electrical generators (as the magnets in each rotor 316 rotate in proximity to the conducting coils in each stator 312). As will be discussed in greater detail below, the curved shape, size and spacing of the airfoils 325 are designed for optimal airfoil rotation by optimizing the number of times an air molecule collides inside the module 310 and transfers its kinetic energy to the airfoils 325.

In one embodiment, the airfoils 325 are oriented at a stagger angle so that the angle of relative velocity of each airfoil 325 does not exceed its stall angle. Airfoils 325 also cause air molecules to compress in a central collection area inside module 310 as well as provide a self-braking effect (e.g., so that the rotors 316 cannot spin out of secure rotation values).

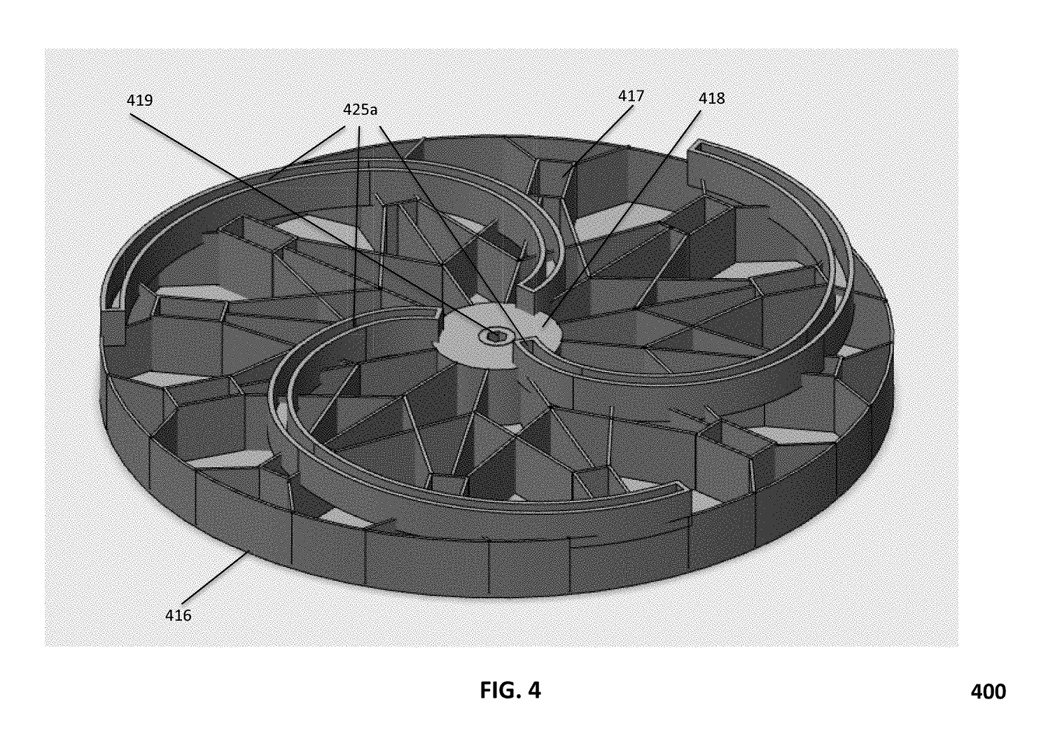

Image 400 of FIG. 4 illustrates an isometric projection of one embodiment of one of the two rotors of each single wind turbine module of the present invention, into which the magnet elements of an integrated generator are incorporated. Rotor 416 (circular in this embodiment) includes magnet slots 417 into which magnets are secured—in one embodiment spaced at even intervals near the outer periphery of rotor 416. One edge of each of the three airfoils of each wind turbine module is also attached to rotor 416 at airfoil slots 425a.

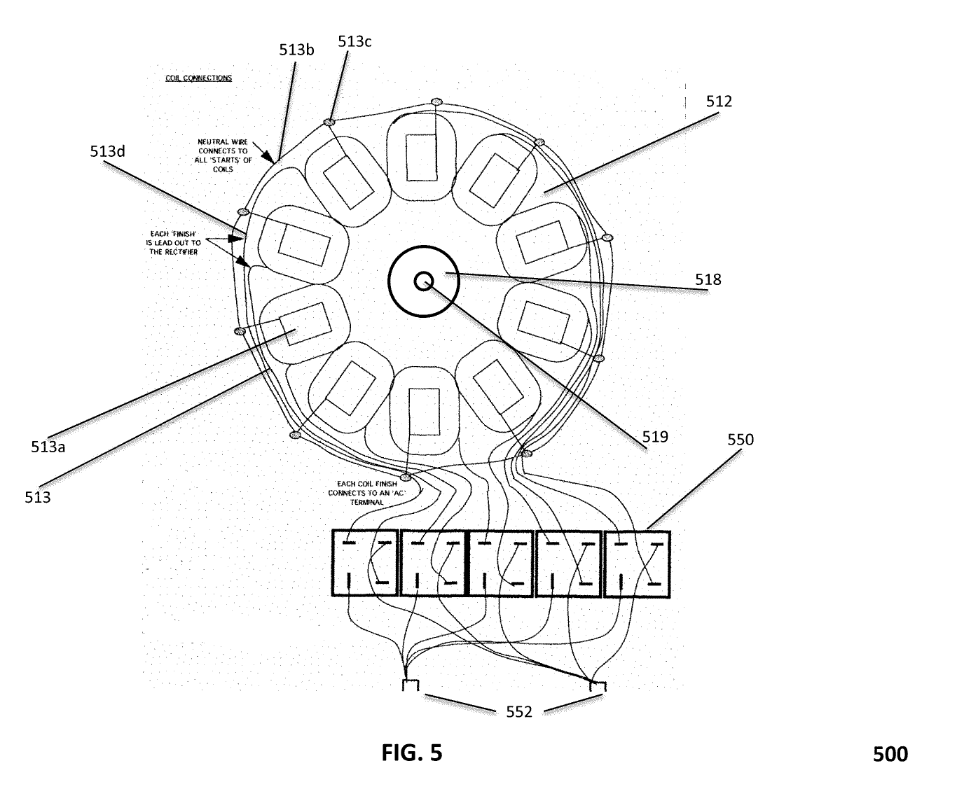

In this manner, when wind causes the airfoils to rotate, rotor 416 (attached to each side of the airfoils at airfoil slots 425a) will also rotate, as will the magnets affixed to magnet slots 417. Because rotor 416 is attached (at central stator-rotor attachment point 419) in proximity to its corresponding stator 512 (illustrated in FIG. 5 below), rotor 416 will rotate around the corresponding central axis of fixed stator 512, and the attached magnets will therefore rotate in proximity to the conducting coils 513 attached to fixed stator 523, thereby generating electricity (i.e., converting mechanical energy of the rotating airfoils—resulting from the wind's kinetic energy—into electrical energy as the magnets rotate in proximity around the conducting coils 513).

In other words, each wind turbine module includes an integrated dual generator (one generator on each end of the three airfoils) consisting of the magnets (attached to rotor 416 at magnet slots 417) and the conducting coils 513 attached to fixed stator 512—which are in proximity to each other due to the proximate attachment of rotor 416 to fixed stator 512 at central stator-rotor attachment point 419.

As is evident from image 400, the shape and location of the airfoils (as illustrated by airfoil slots 425a) leaves a “space” or central collection area 418 in the middle of each rotor 416 that extends “inside” the airfoils along their entire length (i.e., between the two rotors 416 to which the airfoils are attached). This central collection area 418 is quite significant in that the precise size, shape and spacing of the airfoils “forces” air molecules entering each wind turbine module into this central collection area 418, where they produce a number of significant benefits.

These benefits, discussed in greater detail below, include enhanced safety (from the substantially enclosed architecture of each wind turbine module), increased energy efficiency (from a greater number of collisions, as well as compression of air molecules), substantial noise reduction (by slowing and directing the flow of escaping air molecules), and a self-braking effect (as the finite amount of space within the central collection area gradually prevents air molecules from entering the increasingly dense “high pressure” central collection area, and they instead flow out of the back end of the wind turbine, thereby causing the wind turbine to reach an equilibrium as it approaches a maximum rotational speed slightly below its survival speed).

In one embodiment, each rotor 416 is constructed of ABS plastic with carbon fiber for stability, and is attached (at central stator-rotor attachment point 419) to its corresponding stator 512 by an 8mm standard steel (tempered) bolt. The side of each rotor 416 toward its corresponding stator 512 is flat metal, while the other side includes rectangular magnet slots 417 for attaching magnets and protruding flanges or airfoil slots 425a for attaching the three airfoils (protruding out from the surface of each rotor 416 for rigidity and stability, and to limit skew forces).

Turning to FIG. 5, image 500 illustrates a profile view of one embodiment of one of the two stators of each single wind turbine module of the present invention, into which the coil elements of an integrated generator are incorporated, and from which electrical power is generated and distributed to its intended destination. Fixed stator 512 includes attached conducting coils 513 which, as noted above, constitute a key part of the integrated generator that generates electricity when the magnets attached to rotor 416 rotate around the central axis proximately connecting stator 512 to rotor 416 at central stator-rotor attachment point 519 (at the center of central collection area 518).

In one embodiment, copper conducting coils 513 include a plurality of connected “subcoils” 513a, where each subcoil 513a corresponds to a fixed magnetic field opposite a rotating magnet from rotor 416 (illustrated in an oval shape for attachment via an interior rectangular hole slightly exceeding the shape of each rectangular magnet of rotor 416). Conducting coils 513 also include a neutral wire 513b which connects to the “start” 513c of each subcoil 513a, while the “finish” 513d of each subcoil 513a is connected to rectifier 550 for distribution to its intended destination (e.g., a battery 552). It will be evident to one skilled in the art that the “finish” ends of each subcoil 513a from both rotors of each wind turbine module (including embodiments having multiple wind turbine modules) can be “daisy-chained” together to make this connection to rectifier 550.

In one embodiment, rectifier 550 converts the incoming AC power generated by the integrated generator of each wind turbine module from the conducting coils 513 (typically relatively low voltage and high amperage) into DC power for storage by battery 552. In other embodiments, an inverter is employed to convert the DC power back into AC power to match the appropriate AC power requirements (i.e., voltage and current) of a home's electrical power infrastructure, with excess capacity distributed to the existing centralized utility power grid.

In one embodiment, each stator 512 is constructed of ABS plastic with carbon fiber for stability. Each subcoil 513a of the copper coils 513 “snaps” into a rectangular hole in stator 512 creating during manufacturing, thereby enabling replaceable subcoil 513a components for varying voltage and amperage requirements (e.g., 12V, 48V, 72V, etc., with thicker threads employed for higher amperages). In other embodiments, subcoils 513a are glued onto stator 512 or otherwise more permanently affixed.

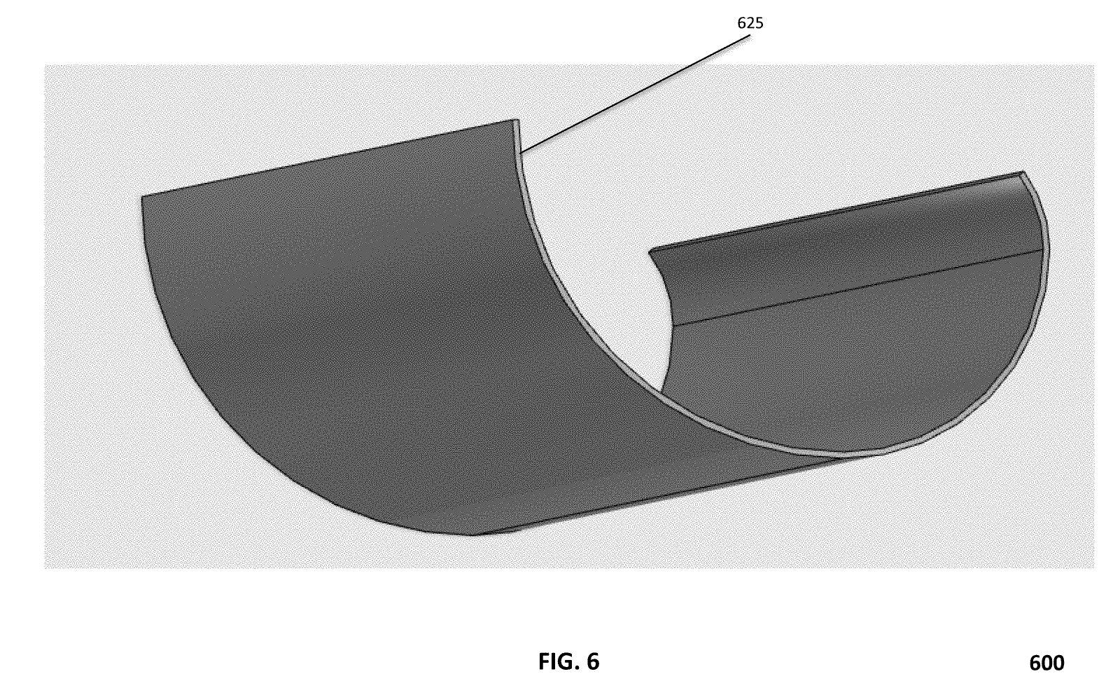

Image 600 of FIG. 6 illustrates an isometric projection of one embodiment of one of the three airfoils of each single wind turbine module of the present invention. Airfoil 625 is constructed from an ABS plastic with glass or carbon fiber for rigidity, while an aluminum extrusion is employed in other embodiments. Those skilled in the art may select different materials for airfoil 625 without departing from the spirit of the present invention.

Airfoil 625 is illustrated in a “Fibonacci-shaped” curve. In other words, the curvature of airfoil 625 is constructed beginning with a central “starting point” representing the center of a circle of a given radius, and curving with a gradually increasing radius toward the “outside” (e.g., corresponding to the “outside” end of each airfoil slot 425a shown near the perimeter of rotor 416 in FIG. 4). In one embodiment, this gradually increasing radius conforms to that of a “Fibonacci series”, thereby generating an airfoil 625 with a “Fibonacci spiral” or “golden spiral” shape.

In other embodiments, those skilled in the art may construct the shape of each curved airfoil 625 by gradually increasing its radius from its center toward the outside in accordance with some other series or function without departing from the spirit of the present invention. In any event, the curved shape of airfoil 625, unlike a parabolic or “bowl-like” shape of many existing airfoils, results in an increased number of collisions of air molecules with the airfoils within each wind turbine module, and thus more captured and converted energy.

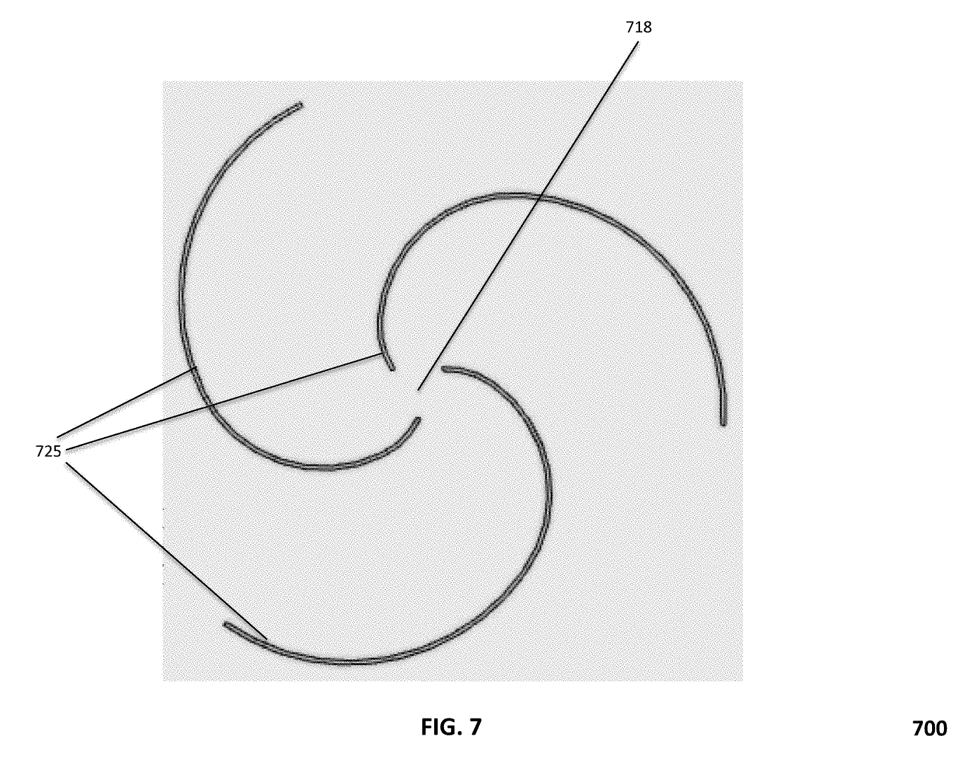

Consider, for example, a single collision between an air molecule and a flat propeller blade, in which roughly half of the kinetic energy of the air molecule is captured/converted into mechanical energy (i.e., turning the propeller). The curved shape of airfoil 625 generates a centripetal force that forces each air molecule inwards, such that it bounces off the airfoil 625 multiple times (releasing more of its remaining energy), as it is directed into central collection area 718 (illustrated in FIG. 7 below).

Turning to FIG. 7, image 700 illustrates a profile view of one embodiment of all three airfoils 725 of each single wind turbine module of the present invention, the spacing of which creates a central collection area 718 into which air molecules are directed. Central collection area 718 is also depicted in item 418 of FIG. 4, which illustrates that the innermost attachment points (closest to the center of each rotor 416) of the airfoils 725 do not meet in the center of each rotor 416 (which would isolate air molecules into separate “compartments” and cause them to leave their compartment more easily).

Instead, in one embodiment, the innermost attachment points of the three airfoils 725 are spaced apart such that they represent three equidistant points on the perimeter of the circular central collection area 718 surrounding the center of each rotor 416, which facilitates the “shared” collection of air molecules (entering at any of the airfoils 725) within central collection area 718, from which they cannot easily leave the wind turbine module—e.g., due to the centripetal force generated by the rotating airfoils 725. This central collection area 718 (and 418) represents “empty space” that extends between the two rotors 416 along the “inside” of the airfoils 725.

To appreciate the advantages of the size, curvature and spacing of airfoils 725, consider, for example, Betz's law, which defines the maximum power that can be extracted from the wind, but which assumes a 90-degree collision angle (e.g., with a flat-blade propeller) to extract the energy. The Fibonacci-shaped curved airfoils 725 of the present invention extract energy at virtually any angle, and can thus be even more efficient as more collisions occur, and those air molecules are directed inward toward central collection area 718. As a result, more energy is captured/converted per air molecule. Moreover, because air molecules compress, allowing more air molecules within central collection area 718 (as noted above), additional collisions occur and even greater energy efficiency is achieved.

In one embodiment, the radius of circular central collection area 718 and the precise size and curvature of each airfoil 725 are selected to maximize the energy efficiency of each wind turbine module, while maintaining sufficient noise reduction and self-braking effects to render the wind turbine system suitable for residential as well as commercial and other applications. Those skilled in the art may select different sizes and curved shapes of each airfoil 725 and different radii (and even different non-circular shapes) of central collection area 718 (and thus achieve different levels of energy efficiency, noise reduction, self-braking and other benefits) without departing from the spirit of the present invention.

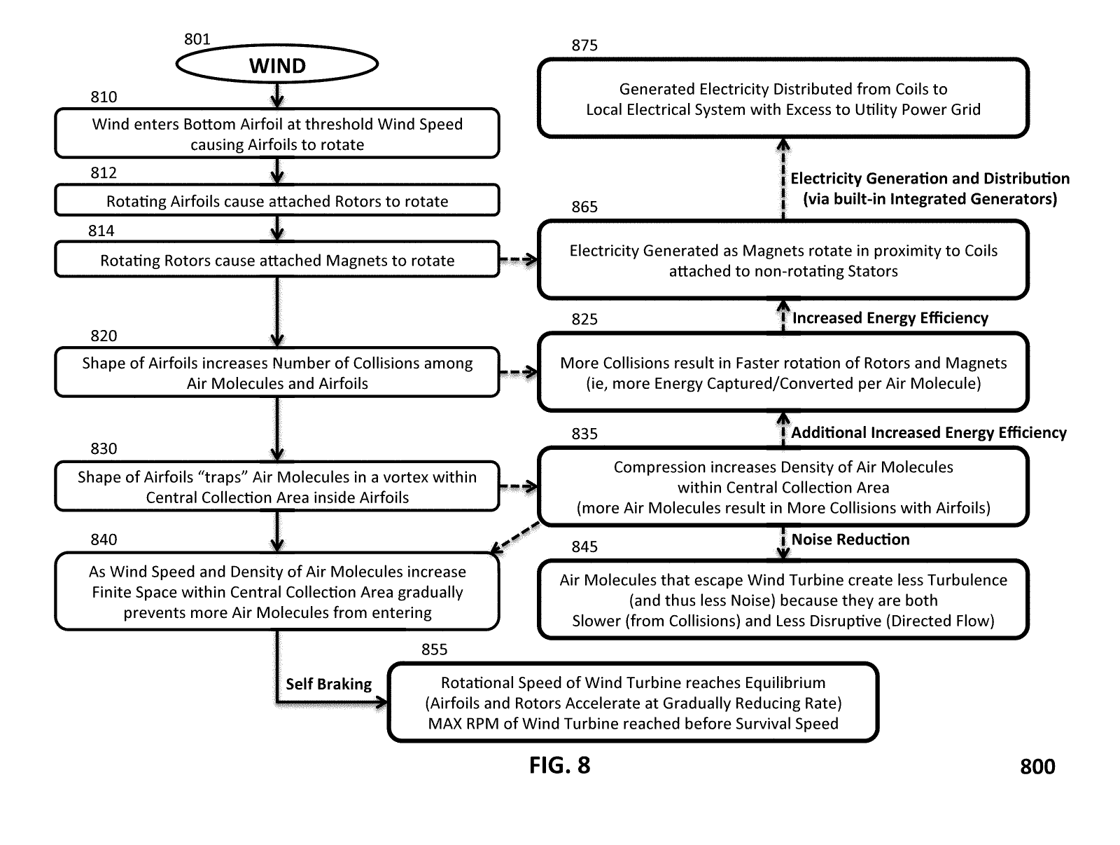

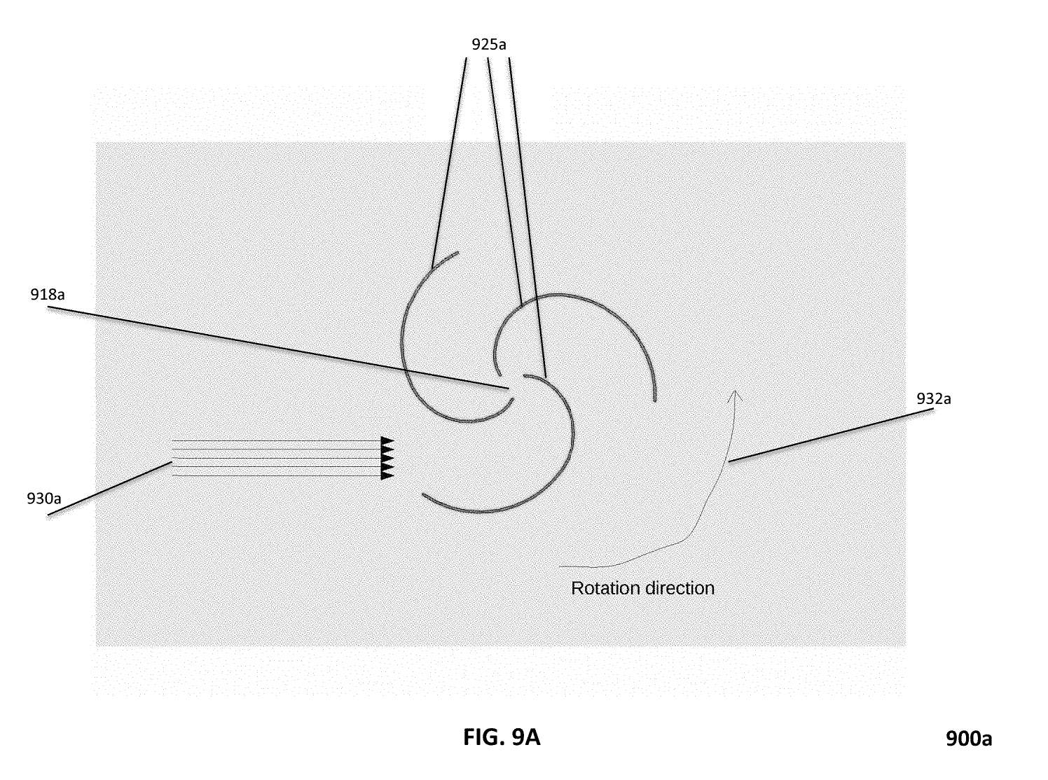

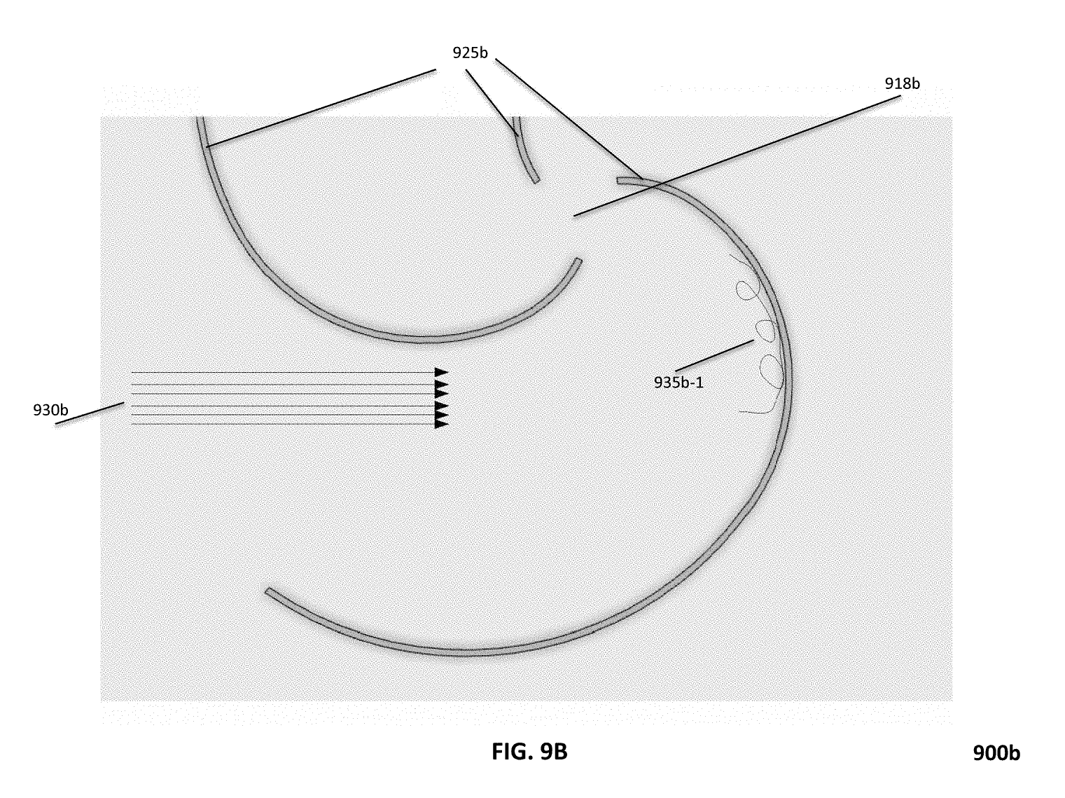

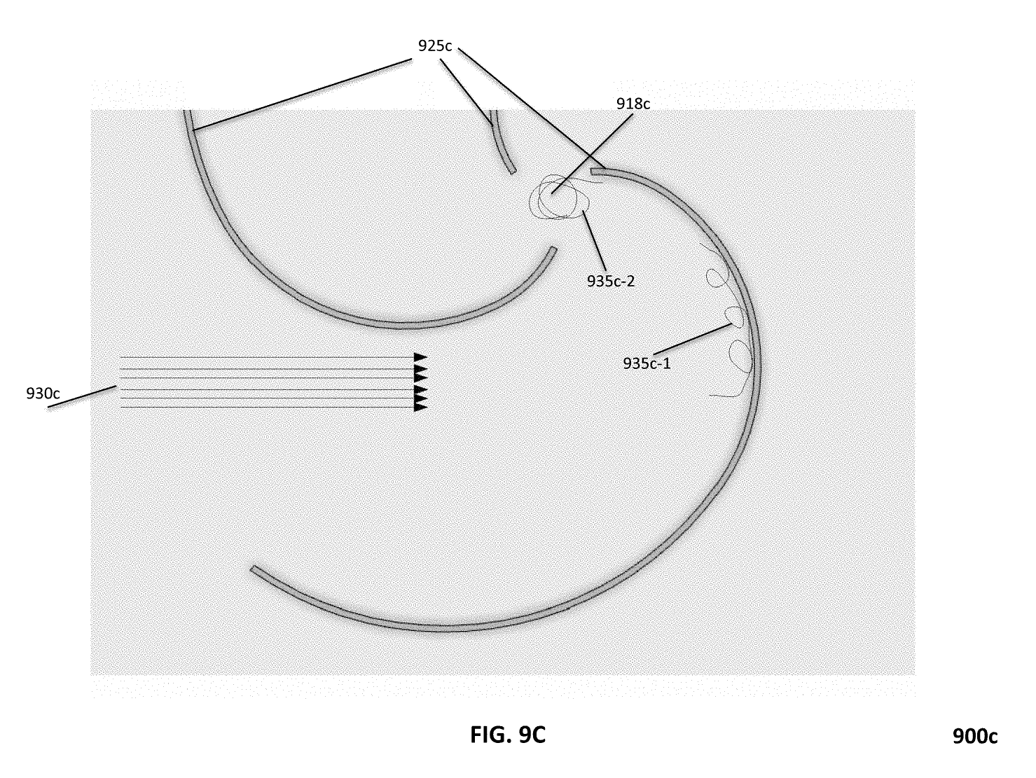

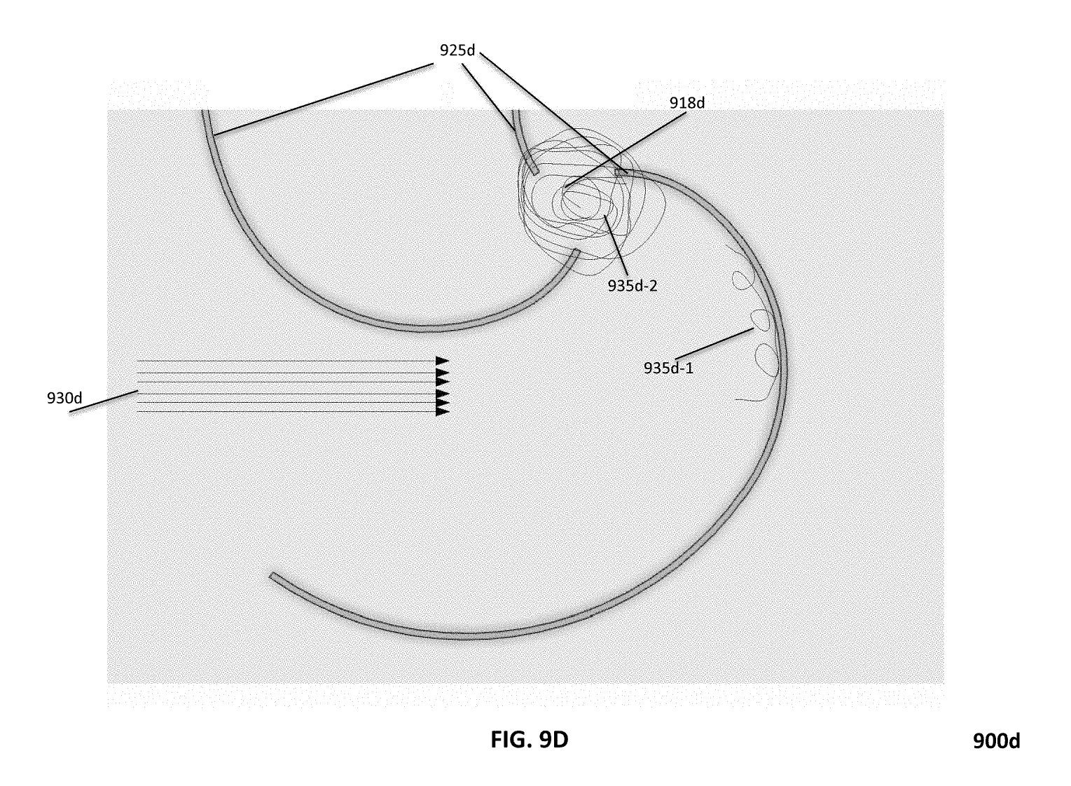

Turning to FIG. 8, flowchart 800 illustrates one embodiment of a dynamic process by which a single wind turbine module (as well as multiple cascading wind turbine modules) of the present invention generates electricity from wind. The following description of flowchart 800 (including references to “snapshot” depictions in FIGS. 9A-9D of the dynamic flow of air molecules through each wind turbine module) provides a clearer understanding of how the benefits of this dynamic process are achieved—many of which were alluded to above, such as electricity generation via an integrated generator, increased energy efficiency, noise reduction and self-braking.

Beginning with step 801, the speed of the wind supplies kinetic energy as input to each module of the wind turbine system. Once the wind speed reaches a lower threshold in step 810, as depicted in profile image 900 of FIG. 9A, the wind 930a entering the lower of the three airfoils 925a in each module causes the airfoils 925a to rotate in a counterclockwise direction 932a around its central axis—i.e., the central stator-rotor attachment point 419 at the center of central collection area 918a. As a result, in step 812, the rotating airfoils 925a cause the attached rotors (on both ends of the airfoils 925a) to rotate in that same direction 932a. In step 814, because the magnets are affixed to each rotor, the rotating rotors also cause the magnets to rotate in that same direction 932a.

Though not shown, note that the poles of the rotating magnets (alternating among each adjacent magnet, in one embodiment) reverse their orientation each half-rotation around the fixed stators, to which the conducting coils are attached, thereby creating a rotating magnetic field in proximity to the conducting coils. As a result, in step 865, AC electricity is generated at the conducting coils of each rotor, thereby completing the “electricity generation” stage of process 800 (illustrated by the arrow from step 865 to “distribution” step 875) in which each wind turbine module of the present invention generates electricity via a “built-in” integrated dual generator.

The particular voltage and amperage characteristics of this AC electricity are determined by the properties of the conducting coils. In one embodiment, as noted above, replaceable subcoil 513a components are employed to facilitate varying voltage and amperage requirements (e.g., in the electrical system of a home, commercial utility or other intended destination).

In step 875, the generated electricity is distributed from the conducting coils to its intended destination. In one common embodiment, this intended destination is a home's electrical system, with excess electricity distributed back to the connected commercial utility power grid. In another embodiment, excess electricity is stored in a home's local battery bank.

In one embodiment, discussed above, the generated AC electricity is first distributed from the conducting coils (attached to each rotor of each wind turbine module) through an externally connected rectifier 550, where it is converted to DC power—e.g., for connection to battery 552. As noted above, an inverter is employed in another embodiment to convert the DC power back into AC power to match the appropriate AC power requirements, for example, of a home's electrical power infrastructure, with excess capacity distributed to the existing centralized utility power grid. Other forms of electricity distribution will be evident to those skilled in the art without departing from the spirit of the present invention.

As each wind turbine module continues to generate electricity, it should be noted that, as indicated in step 820 and depicted in image 900b of FIG. 9B, the curved shape of the airfoils 925b increases the number of collisions among the air molecules and the airfoils 925b. In particular, as the wind 930b enters each module, each of the air molecules 935b-1 initially collides with and bounces off the lower of the three airfoils 925b multiple times due to the curved shape of the airfoils 925b.

As noted above, some of the kinetic energy from each air molecule is captured with each such collision, as more and more of its remaining energy is captured and converted to electricity. In particular, as indicated in step 825, these additional collisions (due to the curved shape of the airfoils 925b) result in a faster rotation of the airfoils 925b, and thus of the attached rotors and magnets, which in turn causes more energy to be captured and converted per air molecule. This “increased energy efficiency” stage of process 800 is illustrated by the arrow from step 825 back to step 865 where this additional electricity is generated.

As noted above, the curved shape of the airfoils 925b not only results in more collisions per air molecule, the centripetal force generated by the rotating airfoils 925b also forces the air molecules 935b-1 inwards into the central collection area 918b. As a result, as indicated in step 830 (and depicted in image 900c of FIG. 9C), as the wind 930c enters each module, the curved shape of the airfoils 925c causes the air molecules 935c-1 to endure multiple collisions with the lower of the three airfoils 925c, and then be forced inwards where those air molecules 935c-2 create a vortex within central collection area 918c.

Moreover, as these slower air molecules 935c-2 (having lost some of their kinetic energy) are forced into central collection area 918c by the centripetal force generated by the rotating airfoils, air molecules 935c-2 are compressed, as indicated in step 835, allowing more air molecules to collide with the airfoils 925b, thereby further increasing the energy efficiency of each wind turbine module.

In other words, this compression enables additional collisions between the airfoils 925c and more air molecules, which in turn results in a faster rotation of the airfoils 925c, and thus of the attached rotors and magnets, resulting in even more energy being captured and converted per air molecule (and among more air molecules). This “additional increased energy efficiency” stage of process 800 is illustrated by the arrow from step 835 back to step 825, and ultimately back to step 865 where this additional electricity is generated.

Another effect of additional air molecules 935c-2 being compressed within central collection area 918c is a reduction in the external noise produced by escaping air molecules, as indicated in step 845, due to the decreased turbulence resulting from slower air molecules escaping in a directed flow out the back of each wind turbine module. This “noise reduction” stage of process 800 is illustrated by the arrow from step 835 to step 845.

Yet, as noted above, the substantially enclosed architecture of the wind turbine system and the airfoils of the present invention inherently produces a self-braking effect that avoids the need for an external braking mechanism. As indicated in step 840 (and depicted in image 900d of FIG. 9D), as the speed of the wind 930d increases, and the density of the air molecules 935d-2 within central collection area 918d increases, the finite amount of space within the wind turbine module (in particular within central collection area 918d) gradually prevents additional air molecules 935d-1 from entering the increasingly dense “high pressure” central collection area 918d, and they instead flow out of the back end of each wind turbine module.

As a result, the rate of compression (and thus the acceleration of the airfoils 925d) gradually decreases, and this self-braking effect, as indicated in step 855, prevents the rotational speed of each wind turbine module from exceeding its survival speed. In other words, even as wind speed continues to increase, the wind turbine module reaches an equilibrium as it approaches a maximum rotational speed (which, in one embodiment, is slightly below its survival speed, to avoid failure or destruction of each wind turbine module).

In one embodiment, the size, curvature and separation of the airfoils 925d is selected so as to optimize energy efficiency—i.e., the highest maximum RPM (e.g., 275) at the highest wind speed (e.g., 7 m/sec) before safety and failure become an issue. In other embodiments, optimal energy efficiency is but a single factor in a tradeoff against other desired benefits, such as noise reduction, turbine failure and safety. It will be apparent to those skilled in the art that varying the size, curvature and separation of airfoils 925d (and thus varying the size of central collection area 918d) will produce this self-braking equilibrium or maximum energy efficiency at various different external wind speeds without departing from the spirit of the present invention.

The above explanation of the embodiments of the present invention set forth in this specification, including the attached Figures, describes an inexpensive, modular micro wind turbine system that is well-suited for residential as well as commercial and other installations. The use of a minimal set of components (two stators with conducting coils, two rotors with affixed magnets and three “Fibonacci-shaped” airfoils in one embodiment) produces a small, light and quiet wind turbine system that can be distributed in a flat package that facilitates retail distribution, and can be installed as one or more aesthetically pleasing, horizontally-oriented low-profile modules (or as a cascading series of daisy-chained modules) near the apex of virtually any residential rooftop.

It's integrated dual generator enables the wind turbine system to generate electricity from a single standalone wind turbine module or a cascading series of multiple such modules without the need for an external generator. The substantially enclosed architecture of each wind turbine module enhances safety and reliability (e.g., by avoiding a high mast and exposure of key components to the elements), while the substantially enclosed design of the airfoils (including their size, shape, curvature and spacing) improves energy efficiency (particularly important in intermittent wind conditions). For example, it results in more collisions with the airfoils per air molecule, directing, trapping and compressing air molecules in a central collection area, which in turn further increases energy efficiency by allowing more collisions among more molecules.

This architecture yields further benefits, including external noise reduction produced by escaping air molecules (due to the decreased turbulence resulting from slower air molecules escaping in a directed flow out the back of each wind turbine module) and a self-braking effect which further enhances safety and reduces equipment failure (including coil burnout), by maintaining a maximum rotational speed even when external wind speed continues to increase (in one embodiment, by sizing the central collection area to a capacity that prevents additional air molecules from entering the central collection area)—thereby avoiding the need for an external braking mechanism.

It will be apparent to those skilled in the art that variations of a number of different features and characteristics of the above-described embodiments will yield many of these benefits without departing from the spirit of the present invention—including, without limitation, varying the number and orientation of individual wind turbine modules and components thereof, the materials utilized to manufacture such components, the size, shape, number and placement of generator components (such as magnets and conductive coils) incorporated within the wind turbine components (including stators, rotors and airfoils) to generate electricity without requiring an external generator, the size, shape, curvature and spacing of the airfoils, and the resulting size and shape of the central collection area (to increase energy efficiency, reduce noise and produce a self-braking effect), and a number of other features and characteristics apparent to those skilled in the art from the descriptions and Figures contained herein.

1. A wind turbine module capable of generating electricity from wind without an external generator, the wind turbine module comprising:
(a) a pair of circular fixed stators, each stator incorporating one or more conducting coils and a mount to affix each stator to a structure;
(b) a pair of circular rotors, each rotor incorporating one or more magnets, wherein each rotor is attached to a corresponding one of the stators at a central axis, such that each rotor can freely rotate around the central axis relative to its corresponding stator; and
(c) a plurality of curved airfoils attached at each end to one of the pair of rotors, such that the plurality of airfoils, including the attached plurality of rotors with affixed magnets, rotates around the central axis when air molecules enter the wind turbine module, thereby creating a rotating magnetic field which generates electricity at the conducting coils.

2. The wind turbine module of claim 1, wherein the curved shape of the plurality of airfoils produces an increased number of collisions between air molecules entering the wind turbine module and the plurality of airfoils, thereby increasing energy efficiency of the wind turbine module.

3. The wind turbine module of claim 1, wherein the innermost attachment points of the plurality of airfoils are spaced apart, relative to the center of each rotor, such that they represent equidistant points on the perimeter of a circular central collection area that extends between the plurality of rotors inside the plurality of airfoils.

4. The wind turbine module of claim 3, wherein the curved shape and spacing of the plurality of airfoils forces air molecules entering the wind turbine module into the central collection area, thereby reducing noise generated by the wind turbine module by releasing slower air molecules in a directed flow out the back end of the wind turbine module.

5. The wind turbine module of claim 4, wherein the air molecules are compressed within the central collection area as a result of losing some of their kinetic energy from the collisions with the plurality of airfoils, as well as a centripetal force generated by rotating airfoils, thereby further increasing energy efficiency of the wind turbine module by forcing an increasing number of air molecules into the central collection area.

6. The wind turbine module of claim 3, wherein the curved shape and spacing of the plurality of airfoils produces a self-braking effect in which the wind turbine module reaches a maximum rotational velocity, despite increasing wind speed, as the central collection area becomes more dense and prevents more air molecules from entering the central collection area, causing the air molecules to exit out the back of the wind turbine module.
